(19) United States
(12) Patent Application Publication
(10) Pub. No.: US 2011/0252092 A1
(43) Pub. Date: Oct. 13, 2011

(54) ELECTRONIC CONFERENCING SYSTEM, ELECTRONIC CONFERENCE OPERATIONS METHOD, COMPUTER PROGRAM PRODUCT, AND CONFERENCE OPERATIONS TERMINAL

(75) Inventor: Tatsuaki Amemura, Osaka (JP)

(73) Assignee: SHARP KABUSHIKI KAISHA, Osaka (JP)

(21) Appl. No.: 13/080,271

(22) Filed: Apr. 5, 2011

(30) Foreign Application Priority Data
Apr. 9, 2010 (JP) 2010-090749

(51) Int. Cl. G06F 15/16

(52) U.S. Cl. 709/204

(57) ABSTRACT

An electronic conferencing system is provided with a conference operations terminal to be operated at an electronic conference and a participation terminal to be applied to participation in the electronic conference. The conference operations terminal is provided with a storage portion that stores a conferencing program to be applied to the electronic conference, a recognition count determination unit that determines a recognition count based on participation terminals recognized by a participation terminal recognition unit that recognizes participation terminals, and a conferencing program activation unit that activates the conferencing program, when the recognition count determination unit determines that the recognition count equals a set recognition count that is preset.

### CROSS REFERENCE TO RELATED APPLICATION

This application claims priority under 35 U.S.C. §119(a) on Patent Application No. 2010-090749 filed in Japan on Apr. 9, 2010, the entire contents of which are herein incorporated by reference.

### BACKGROUND OF THE INVENTION

1. Field of the Invention

The present invention relates to an electronic conferencing system to which a conference operations terminal and a participation terminal are applied, an electronic conference operations method of the electronic conferencing system, a computer program product for causing a computer to function as the conference operations terminal of the electronic conferencing system, and the conference operations terminal applied to the electronic conferencing system.

2. Description of the Related Art

Conventionally, communication means such as telephone, fax and e-mail have been used to achieve communication within the company and with business partners. However, with product development meetings and the like, product development cannot be pursued efficiently by communicating only by e-mail or other convenient means of communication, since discussions need to take place while actually viewing design plans and related material.

Accordingly, the need arises for all of the parties concerned to get together, although this is problematic in terms of time and distance if the concerned parties are far apart. As a way of resolving this problem, there is increasingly widespread use of electronic conferencing systems (TV conferencing systems, Web conferencing systems, etc).

Video conferencing systems having a video conferencing program, a PC for each user, a digital camera and a cradle have been proposed (e.g., see JP 2002-23040A; hereinafter, Patent Document 1). With this video conferencing system, the video conferencing program is activated automatically when it is detected that the user places the digital camera in the cradle and makes a connection enabling bidirectional communication with the user's PC.

Electronic conferencing systems provided with two or more PCs equipped with USB interfaces and connected to the Internet, and an external storage medium equipped with a USB interface and having installed thereon both conferencing software and software for automatically activating the conferencing software have been proposed (e.g., see JP 2006-11716A; hereinafter, Patent Document 2). With this electronic conferencing system, conferencing software is activated automatically by simply connecting the external storage medium to a PC via the USB interface after powering on the PC.

However, the following problems exist with the techniques of Patent Documents 1 and 2 described as background art.

With the video conferencing system disclosed in Patent Document 1, the timing at which the electronic conferencing system is activated is completely reliant on a manual operation by a participant, given that placement of a digital camera by a user in a cradle is prerequisite for activating the electronic conferencing system. Similarly, with the electronic conferencing system disclosed in Patent Document 2, the timing at which the electronic conferencing system is activated is completely reliant on a manual operation by a participant, since a user needs to connect an external storage medium having a USB interface.

In other words, there is a problem in that in the case where the desire is to activate the electronic conferencing system when a certain number of people (quorum) have assembled or when a certain specific attendee (participant) is present, the electronic conferencing system cannot be activated until the person in charge of activating the electronic conferencing system has got a grasp of the situation with the participants and confirmed that the conditions for opening the conference have been satisfied.

### SUMMARY OF THE INVENTION

The present invention has been made in consideration of such a situation, and has as an object to provide an electronic conferencing system provided with a conference operations terminal to be operated at an electronic conference and a participation terminal to be applied to participation in the electronic conference, and that relieves/eases the load on users (operators, participants) of the electronic conferencing system, by eliminating the need for necessary tasks such as activating the conference program performed by the person in charge when starting an electronic conference, because the conferencing program is automatically activated by recognizing participation terminals.

The present invention has another object to provide an electronic conference operations method of the electronic conferencing system according to the present invention.

The present invention has yet another object to provide a computer program product for causing a computer to function as the conference operations terminal according to the present invention.

The present invention has yet another object to provide a conference operations terminal to be applied to the electronic conferencing system according to the present invention.

An electronic conferencing system according to the present invention is an electronic conferencing system provided with a conference operations terminal to be operated at an electronic conference and a participation terminal to be applied to participation in the electronic conference, the conference operations terminal including a storage portion that stores a conferencing program to be applied to the electronic conference, a recognition count determination unit that determines a recognition count based on the participation terminal recognized by a participation terminal recognition unit that recognizes the participation terminal, and a conferencing program activation unit that activates the conferencing program, when the recognition count determination unit determines that the recognition count equals a set recognition count that is preset.

Accordingly, in the electronic conferencing system of the present invention, participation terminals to be applied to participation in an electronic conference are recognized using the participation terminal recognition unit. The electronic conferencing system according to the present invention determines the recognition count with a recognition count determination unit based on recognized participation terminals. The electronic conferencing system of the present invention automatically activates a conferencing program using a conferencing program activation unit, when it is determined that participation terminals satisfy a set recognition count that is preset as a prerequisite for opening a conference. Hence, the electronic conferencing system according to the present invention achieves the effect of relieving/easing the load on users (operators/participants) of the electronic conferencing system, by eliminating the need for necessary tasks such as activating the conferencing program performed by an operator when starting an electronic conference.

With the electronic conferencing system according to the present invention, the conference operations terminal may be provided with the participation terminal recognition unit.

Accordingly, the device configuration of the electronic conferencing system of the present invention can be simplified, because the electronic conferencing system causes the conference operations terminal to recognize participation terminals.

With the electronic conferencing system according to the present invention, a plurality of slave terminals that communicate with the conference operations terminal may be provided, and the slave terminals may each include the participation terminal recognition unit.

Accordingly, the electronic conferencing system of the present invention enables the number of participation terminals that can be recognized to be increased according to the number of slave terminals, because of recognizing participation terminals via the slave terminals (via participation terminal recognition units provided in the slave terminals), and is able to relieve restrictions on the number of participation terminals, because of being able to increase the number of participation terminals that can be recognized by providing additional slave terminals, even in the case where there is a restriction on the number of participation terminals that can be recognized with a single participation terminal recognition unit.

With the electronic conferencing system according to the present invention, the slave terminals may include a slave display portion, and the slave display portion may be configured to display a screen for executing the conferencing program received from the conference operations terminal.

Accordingly, the electronic conferencing system of the present invention is able to effectively conduct an electronic conference, because of being able to display a screen for executing a conferencing program (e.g., display a screen for executing a conferencing application program applied to the conferencing program, display a conferencing file applied to the conferencing program, etc.) via a slave terminal (via slave display unit).

With the electronic conferencing system according to the present invention, the conference operations terminal may include a participation terminal information obtaining unit that obtains, from a participation terminal information database that registers participation terminal information held by the participation terminal, participation terminal information corresponding to an authorization condition for participation in the electronic conference, and an authorization determination unit that determines whether the participation terminal information obtained by the participation terminal information obtaining unit meets the authorization condition, the set recognition count may be an authorization recognition count that is preset in association with the authorization condition, and the recognition count determination unit may be configured to determine whether the recognition count of the participation terminal determined by the authorization determination unit to meet the authorization condition equals the authorization recognition count.

Accordingly, the electronic conferencing system of the present invention is able to implement an electronic conference limited to participation terminals satisfying an authorization condition, because of obtaining participation terminal information with a participation terminal information obtaining unit from a participation terminal information database, and determining with an authorization determination unit whether a preset authorization condition has been satisfied with regard to the obtained participation terminal information (with regard to participation terminal).

With the electronic conferencing system according to the present invention, the conference operations terminal may have the participation terminal information database.

Accordingly, the electronic conferencing system of the present invention is able to smoothly run an electronic conference, because of easily and accurately determining whether a participation terminal satisfies an authorization condition for participating in an electronic conference, based on the content (participation terminal information) of a participation terminal information database.

With the electronic conferencing system according to the present invention, the conference operations terminal may be connected to a server via a network, and the server may have the participation terminal information database.

Accordingly, the electronic conferencing system of the present invention is able to smoothly run an electronic conference given that it is easily and accurately determined whether a participation terminal satisfies an authorization condition for participating in the electronic conference. Also, the memory capacity available for participation terminal information can be increased given that the participation terminal information database is provided in a server.

With the electronic conferencing system according to the present invention, the authorization condition may be that a security level set for the participation terminal is greater than or equal to a threshold.

Accordingly, the electronic conferencing system of the present invention is able to run an electronic conference provided with a participation restriction that depends on security level. In other words, measures such as configuring settings so that a participant with a high security level conducts the conference can be adopted, by individually setting the security level with regard to the rank, division or the like of participants, and conferring confirmation authority on a participant with a high security level.

With the electronic conferencing system according to the present invention, a plurality of security levels may be set, a plurality of conferencing programs may be set according to the security levels, and the conferencing program activation unit may be configured to activate the conferencing program corresponding to the security level satisfying the authorization condition.

Accordingly, the electronic conferencing system of the present invention is able to improve reliability with respect to security, by being able to set conferencing programs according to security level (e.g., setting a conferencing program only capable of display when the security level is low, and setting a conferencing program capable of editing as well as display when the security level is high).

With the electronic conferencing system according to the present invention, the conference operations terminal may include a program status determination unit that determines whether a conferencing program is already active, and a priority determination unit that, when the program status determination unit determines that a conferencing program is active, compares a priority of the conferencing program that is active and a priority of a conferencing program that is to be activated, and the priority determination unit may be configured to terminate the conferencing program that is active when the priority of the conferencing program that is to be activated is higher than the priority of the conferencing program that is active, and to terminate processing on the conferencing program that is to be activated when the priority of the conferencing program that is to be activated is lower than the priority of the conferencing program that is active.

Accordingly, the electronic conferencing system of the present invention is able to smoothly run an electronic conference, since the electronic conference (conferencing program) can be selected according to priority.

Also, with the electronic conferencing system according to the present invention, the conferencing program that is activated by the conferencing program activation unit may be one of a conferencing application program to be applied to the electronic conference and a program for displaying a conference file to be used at the electronic conference.

Accordingly, the electronic conferencing system of the present invention is able to efficiently and easily start an electronic conference given that launching of a conferencing application program to be applied to the electronic conference or display of a conference file to be used at the electronic conference is executed.

With the electronic conferencing system according to the present invention, the participation terminal may be a terminal device satisfying a preselected wireless communication standard.

Accordingly, a highly user-friendly and reliable electronic conference system can be realized, given that the electronic conferencing system according to the present invention applies an electronic device equipped with a specific wireless communication standard (e.g., Bluetooth (registered trademark)) as the participation terminal.

With the electronic conferencing system according to the present invention, the conference operations terminal may include a level determination unit that determines a security level of the participation terminal, and a file selection unit that selects a conference file according to the security level determined by the level determination unit, and may be configured to display the conference file selected by the file selection unit on the slave display portion.

Accordingly, the electronic conferencing system of the present invention is able to ensure strict security even if the number of slave terminals is increased, because of detecting the security level of participation terminals for each slave terminal, and displaying a conference file corresponding to the security level of the participation terminals.

An electronic conference operations method according to the present invention is an electronic conference operations method of an electronic conferencing system including a conference operations terminal to be operated at an electronic conference and a participation terminal to be applied to participation in the electronic conference, the conference operations terminal storing a conferencing program to be applied to the electronic conference, and the electronic conference operations method including a recognition count determination step of the conference operations terminal determining a recognition count based on the participation terminal recognized in a participation terminal recognition step of recognizing the participation terminal, and a conferencing program activation step of the conference operations terminal activating the conferencing program, when it is determined in the recognition count determination step that the recognition count equals a set recognition count that is preset.

Accordingly, the electronic conference operations method of the present invention operates similarly to the electronic conferencing system and achieves similar effects.

A computer program product according to the present invention is a computer program product including a computer-readable storage medium having recorded thereon a computer-readable program, the program being for causing a computer to function as a conference operations terminal to be operated at an electronic conference realized by an electronic conferencing system including a participation terminal to be applied to participation in the electronic conference, the conference operations terminal storing a conferencing program to be applied to the electronic conference, and the program, when executed on the computer, causing the computer to execute a recognition count determination step of determining a recognition count based on the participation terminal recognized in a participation terminal recognition step of recognizing the participation terminal, and a conferencing program activation step of activating the conferencing program, when it is determined in the recognition count determination step that the recognition count equals a set recognition count that is preset.

Accordingly, the computer program product of the present invention operates similarly to the electronic conferencing system and the electronic conference operations method, and achieves similar effects.

A conference operations terminal according to the present invention is a conference operations terminal to be operated at an electronic conference realized by an electronic conferencing system including a participation terminal to be applied to participation in the electronic conference, the conference operations terminal including a storage portion that stores a conferencing program to be applied to the electronic conference, a recognition count determination unit that determines a recognition count based on the participation terminal recognized by a participation terminal recognition unit that recognizes the participation terminal, and a conferencing program activation unit that activates the conferencing program, when the recognition count determination unit determines that the recognition count equals a set recognition count that is preset.

Accordingly, a conference operations terminal of the present invention operates similarly to the electronic conferencing system and the electronic conference operations method, and achieves similar effects.

### BRIEF DESCRIPTION OF THE DRAWINGS

FIG. 1 is a schematic diagram conceptually showing an electronic conferencing system and a conference operations terminal according to Embodiment 1 of the present invention.

FIG. 2 is a block diagram showing constituent blocks of the electronic conferencing system and the conference operations terminal shown in FIG. 1.

FIG. 3 is a flowchart illustrating a processing flow of the electronic conferencing system shown in FIG. 2.

FIG. 4 is a data table showing a data configuration example of a participation terminal information database shown in FIG. 2.

FIG. 5 is a block diagram showing constituent blocks of the electronic conferencing system and the conference operations terminal according to Embodiment 2 of the present invention.

FIG. 6 is a flowchart illustrating a processing flow of the electronic conferencing system shown in FIG. 5.

FIG. 7 is a schematic diagram conceptually showing an electronic conferencing system and a conference operations terminal according to Embodiment 3 of the present invention.

FIG. 8 is a block diagram showing constituent blocks of the electronic conferencing system and the conference operations terminal shown in FIG. 7.

FIG. 9 is a schematic diagram showing a display example of participation terminal information displayed on a slave display portion of the slave terminal shown in FIG. 7.

FIG. 10 is a block diagram showing constituent blocks of the electronic conferencing system and the conference operations terminal according to Embodiment 4 of the present invention.

FIG. 11 is a flowchart illustrating a processing flow of the electronic conferencing system shown in FIG. 10.

### DESCRIPTION OF THE PREFERRED EMBODIMENTS

Hereinafter, embodiments of the present invention will be described based on the drawings.

### Embodiment 1

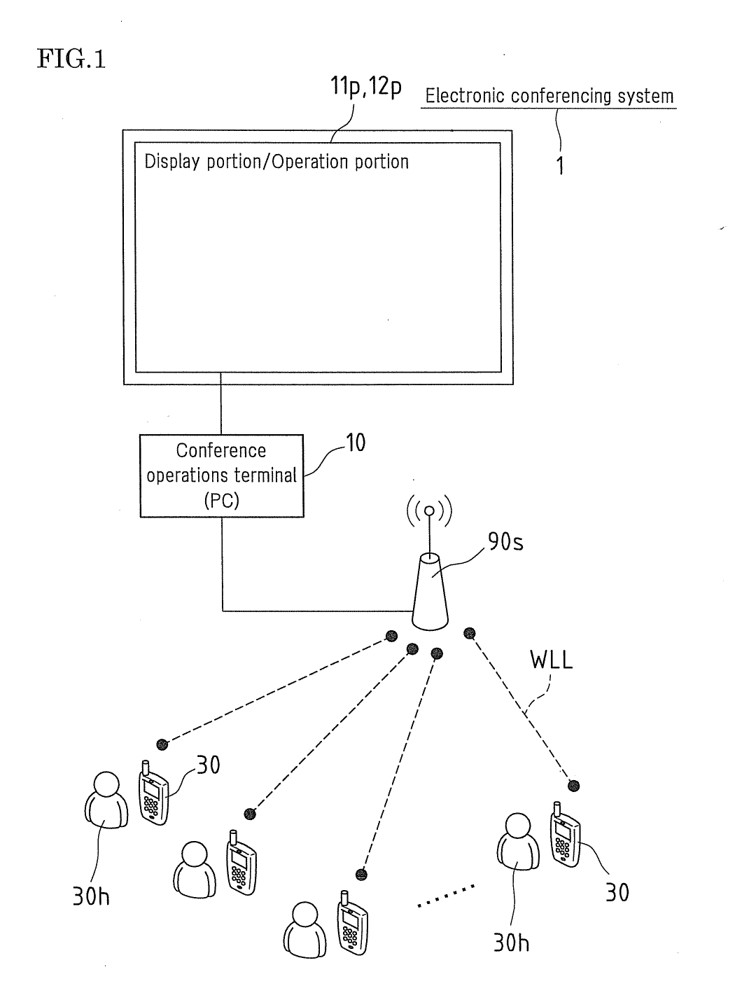

An electronic conferencing system 1 and a conference operations terminal 10 according to the present embodiment will be described with reference to FIGS. 1 through 4.

FIG. 1 is a schematic diagram conceptually showing the electronic conferencing system 1 and the conference operations terminal 10 according to Embodiment 1 of the present invention.

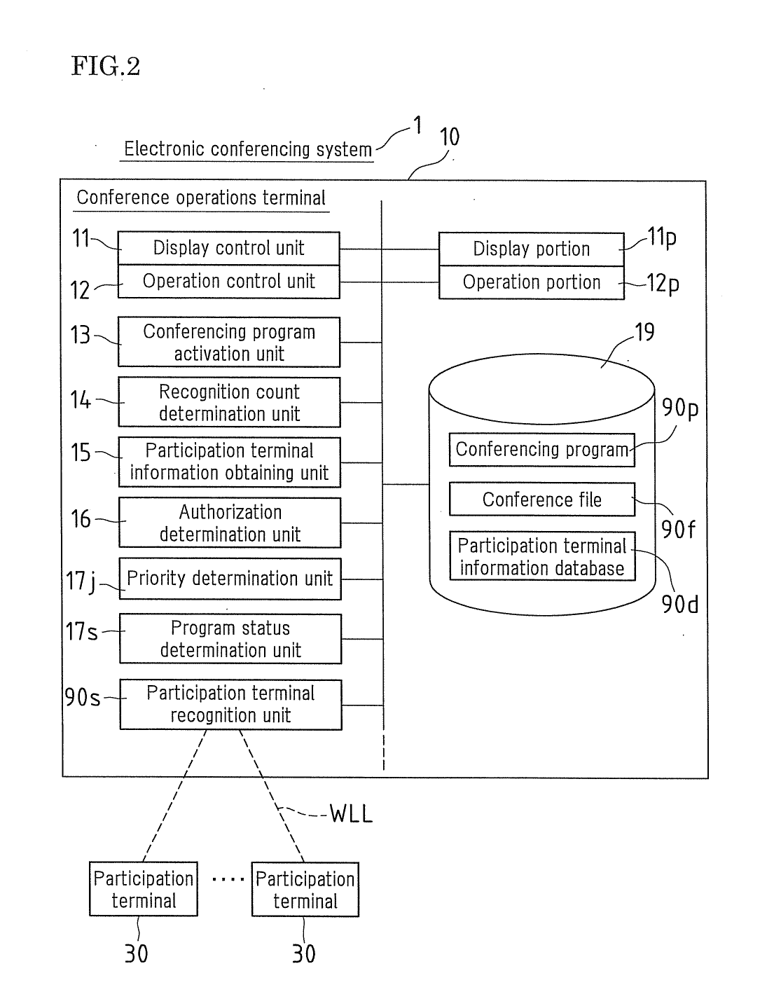

FIG. 2 is a block diagram showing constituent blocks of the electronic conferencing system 1 and the conference operations terminal 10 shown in FIG. 1.

The electronic conferencing system 1 according to the present embodiment is for an operator to run an electronic conference between a plurality of participants. The electronic conferencing system 1 is provided with the conference operations terminal 10 to be operated by the operator at the electronic conference and a plurality of participation terminals 30 to be applied to participation in the electronic conference.

The conference operations terminal 10 runs the electronic conference. The conference operations terminal 10 is provided with a storage portion 19 that stores a conferencing program 90p to be applied to the electronic conference, a recognition count determination unit 14 that determines a recognition count based on participation terminals 30 recognized by a participation terminal recognition unit 90s that recognizes participation terminals 30, and a conferencing program activation unit 13 that activates the conferencing program 90p when the recognition count determination unit 14 determines that the recognition count equals a set recognition count that is preset.

Accordingly, in the electronic conferencing system 1 of the present embodiment, participation terminals 30 to be applied to participation in an electronic conference are recognized using the participation terminal recognition unit 90s. The electronic conferencing system 1 determines a recognition count (e.g., number of participation terminals 30 in a communicable state with the participation terminal recognition unit 90s) with the recognition count determination unit 14 based on recognized participation terminals 30. The electronic conferencing system 1 determines that participants scheduled to participate in the electronic conference are, for example, in attendance, when it is determined that the participation terminals 30 satisfy a set recognition count (e.g., number of participation terminals 30 corresponding to a set quorum (number of terminal holders 30h of participation terminals 30, i.e., number of participants in the electronic conference)) that is preset as a prerequisite for opening the electronic conference, and automatically activates the conferencing program 90p using the conferencing program activation unit 13. Hence, the electronic conferencing system 1 relieves/eases the load on users of the electronic conferencing system 1, by eliminating the need for necessary tasks such as activating the conferencing program performed by an operator when starting an electronic conference.

Note that the conferencing program activation unit 13 calls the conferencing program 90p from the storage portion 19 and activates the conferencing program 90p.

As for the conference operations terminal 10, a terminal having functions on a par with a general PC (personal computer) is applied. The conference operations terminal 10 preferably is a dedicated machine. The conference operations terminal 10 can also be applied by incorporating a computer program according to the present invention in a general PC. As for the participation terminals 30, a terminal device capable of communicating with the conference operations terminal 10 using a wireless communication line WLL is applied, for example. A terminal device satisfying a preselected wireless communication standard (e.g., Bluetooth (registered trademark)) desirably is applied as the participation terminals 30. That is, the conference operations terminal 10 and the participation terminals 30 desirably are capable of wirelessly communicating with each other using a preselected wireless communication standard (e.g., Bluetooth (registered trademark)). The participation terminals 30 are held (controlled) by terminal holders 30h (participants, person eligible for participation).

In other words, the participation terminals 30 desirably are terminal devices that satisfy a preselected wireless communication standard. Accordingly, a highly user-friendly and reliable electronic conferencing system 1 can be realized, given that the electronic conferencing system 1 according to the present embodiment applies an electronic device equipped with a specific wireless communication standard (e.g., Bluetooth (registered trademark)) as the participation terminals 30.

Note that the participation terminals 30 are not limited to a terminal device satisfying a wireless communication standard. An IC card, for example, can also be applied as the participation terminals 30. As for the specific operational functions of such participation terminals 30, a configuration can be adopted in which reading or writing of data on an IC card is performed.

Also, when a conference room in which the electronic conferencing system 1 is implemented (conference room in which the conference operations terminal 10 is installed) is locked, and an IC card is read with an IC card reader provided in a locking device installed in the door, a configuration can also be adopted in which the door is opened by authentication, and a program is activated in conjunction therewith. In this case, the IC card reader functions as the participation terminal recognition unit 90s, and is communicable with the conference operations terminal 10.

In the present embodiment, the conference operations terminal 10 is provided with the participation terminal recognition unit 90s. In other words, the present embodiment is a configuration in which the conference operations terminal 10 incorporates the participation terminal recognition unit 90s. Accordingly, the device configuration of the electronic conferencing system 1 can be simplified, because of the electronic conferencing system 1 causing the conference operations terminal 10 to recognize participation terminals 30. The participation terminal recognition unit 90s is not limited to the present embodiment, and can also be external to the conference operations terminal 10.

There are cases where the number of the participation terminals 30 that can be recognized with the participation terminal recognition unit 90s may be restricted depending on the wireless communication standard applied to the participation terminals 30 to, for example, seven to ten terminals.

The conference operations terminal 10 is provided with a display portion 11p and an operation portion 12p. The display portion 11p and the operation portion 12p are, for example, a large screen display touch panel (display panel doubling as a touch panel), with the operation portion 12p being a touch panel placed over the display portion 11p. The display portion 11p and the operation portion 12p are respectively controlled by a display control unit 11 and an operation control unit 12. Configuring the display portion 11p and the operation portion 12p as a display panel doubling as a touch panel enables an efficient electronic conference to be realized, by facilitating editing tasks such as directly modifying displayed material (e.g., documents serving as conference files 90f to be used at an electronic conference) while viewing a display screen.

The display portion 11p is able to extract and display conference files 90f (e.g., documents to be presented at an electronic conference, documents representing content to be discussed at an electronic conference, etc.) stored in the storage portion 19, for example. For example, the display control unit 11 is able to retrieve a conference file 90f from the storage portion 19, and display the retrieved conference file 90f on the display portion 11p.

The display portion 11p is not absolutely essential, and the conference operations terminal 10 (electronic conferencing system 1) can also be applied to an audio-only electronic conference (telephone conference), for example.

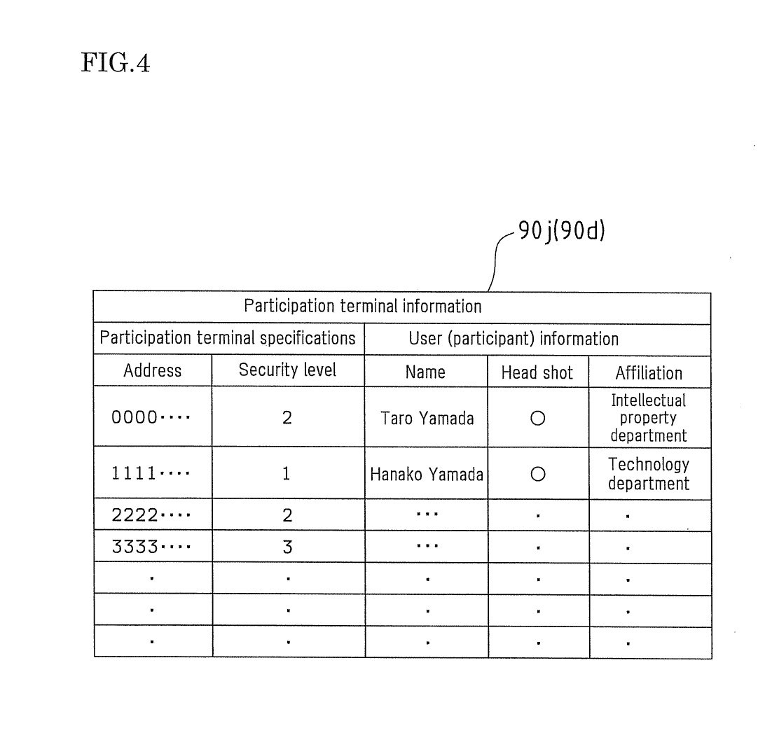

Further, the conference operations terminal 10 is provided with a participation terminal information obtaining unit 15 that obtains, from a participation terminal information database 90d that registers (stores) participation terminal information 90j (see FIG. 4) held by participation terminals 30, participation terminal information 90j (a characteristic variable of the participation terminals 30 used in determining whether the authorization condition has been satisfied; e.g., security level) corresponding to an authorization condition (e.g., security level greater than or equal to a threshold (see FIG. 4)) for participation in an electronic conference, and an authorization determination unit 16 that determines whether the participation terminal information 90j obtained by the participation terminal information obtaining unit 15 meets the authorization condition. The set recognition count is an authorization recognition count that is preset in association with the authorization condition. The recognition count determination unit 14 is configured to determine whether the recognition count of participation terminals 30 determined by the authorization determination unit 16 to meets the authorization condition equals the authorization recognition count.

Accordingly, the electronic conferencing system 1 is able to implement an electronic conference limited to participation terminals 30 satisfying an authorization condition, because of obtaining participation terminal information 90j with the participation terminal information obtaining unit 15 from the participation terminal information database 90d, and determining with the authorization determination unit 16 whether the obtained participation terminal information 90j (participation terminal 30) satisfies a preset authorization condition.

The conferencing program 90p, conference files 90f, and participation terminal information database 90d are stored in the storage portion 19, for example. The storage portion 19 is constituted by a HDD (hard disk), for example.

The conference operations terminal 10 has the participation terminal information database 90d. Accordingly, the electronic conferencing system 1 of the present embodiment is able to smoothly run an electronic conference, because of being able to easily and reliably determine, based on the content of the participation terminal information database 90d (participation terminal information 90j), whether participation terminals 30 satisfy an authorization condition for participation in the electronic conference.

The conference operations terminal 10 stores a plurality of conferencing programs 90p having different functions and priorities, and is able to selectively execute one of the conferencing program 90p.

The conference operations terminal 10 is provided with a program status determination unit 17s that determines whether a conferencing program 90p is already active, and a priority determination unit 17j that, when the program status determination unit 17s determines that a conferencing program 90p is active, compares a priority of the conferencing program 90p that is already active and a priority of a conferencing program 90p that is to be activated.

When the program status determination unit 17s determines that a conferencing program 90p is active, the conferencing program activation unit 13 attempts to activate all of the other conferencing programs 90p except for the conferencing program 90p that is active, and causes the priority determination unit 17j to execute processing with regard to all of the other conferencing programs 90p that it is attempting to activate. When the program status determination unit 17s determines that a conferencing program 90p is not active, the conferencing program activation unit 13 activates the conferencing program 90p having the highest priority. Priorities are dynamically assigned to the conferencing programs 90p, such that a conferencing program 90p corresponding to a characteristic (e.g., smallest value of the security level of participation terminals 30 participating in the electronic conference) of participation terminals 30 participating in the electronic conference (conferencing program 90p) has the highest priority.

The priority determination unit 17j is configured to terminate (or end) the conferencing program 90p that is already active, when the priority of the conferencing program 90p that is to be activated is higher than the priority of the conferencing program 90p that is already active, and to terminate processing of the conferencing program 90p that is to be activated, when the priority of the conferencing program 90p that is to be activated is lower than the priority of the conferencing program 90p that is already active.

The conferencing program 90p having the highest priority among the plurality of conferencing programs 90p can thereby always be executed, even if the conferencing program 90p having the highest priority changes. That is, even if a characteristic (e.g., smallest value of the security level of participation terminals 30 participating in the electronic conference) of participation terminals 30 participating in an electronic conference (conferencing program 90p) changes, a conferencing program 90p that corresponds to the characteristic of participation terminals 30 participating in an electronic conference can thereby always be executed.

Accordingly, the electronic conferencing system 1 of the present embodiment is able to smoothly run an electronic conference, by enabling selection of an electronic conference (conferencing program 90p) according to priority.

Priorities can be set in correspondence to security level (see FIG. 4), for example. Specifically, when the security level of participation terminals 30 participating in an electronic conference (conferencing program 90p) is high, a conferencing program 90p corresponding to a high security level can be set as the conferencing program 90p having the highest priority.

As mentioned above, the conference operations terminal 10 according to the present embodiment is operated at an electronic conference realized by an electronic conferencing system 1 provided with a participation terminal 30 to be applied to participation in the electronic conference, and is provided with a storage portion 19 that stores a conferencing program 90p to be applied to the electronic conference, a recognition count determination unit 14 that determines a recognition count based on participation terminals 30 recognized by a participation terminal recognition unit 90s that recognizes participation terminals 30, and a conferencing program activation unit 13 that activates the conferencing program 90p, when the recognition count determination unit 14 determines that the recognition count equals a set recognition count that is preset.

Accordingly, the conference operations terminal 10 achieves operations and effects similar to the electronic conferencing system 1.

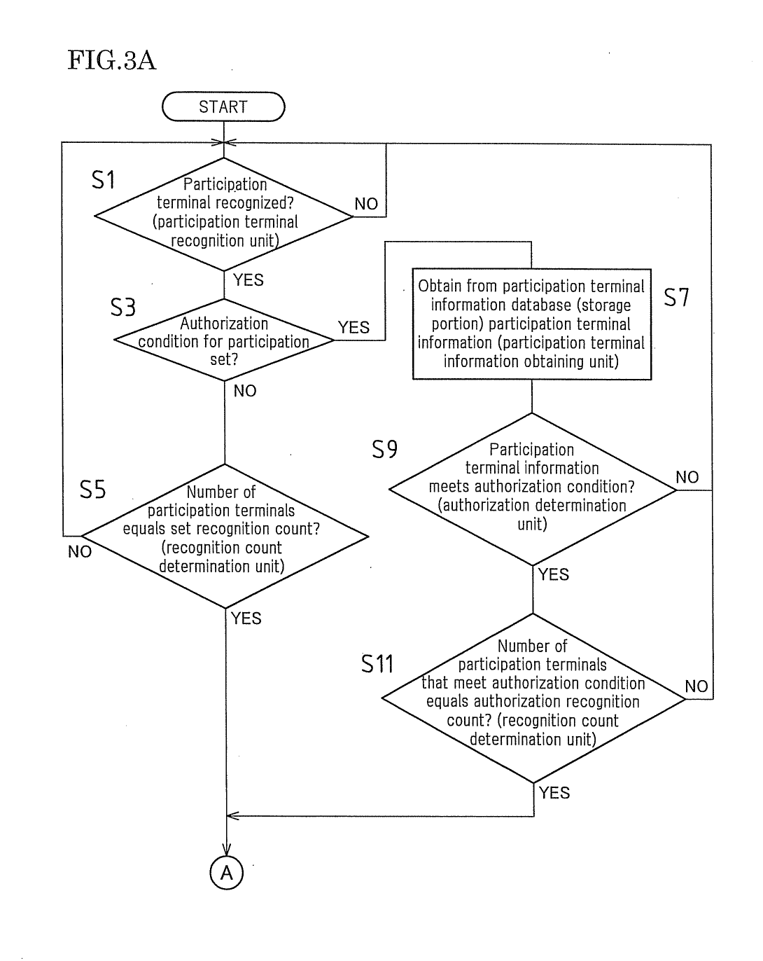

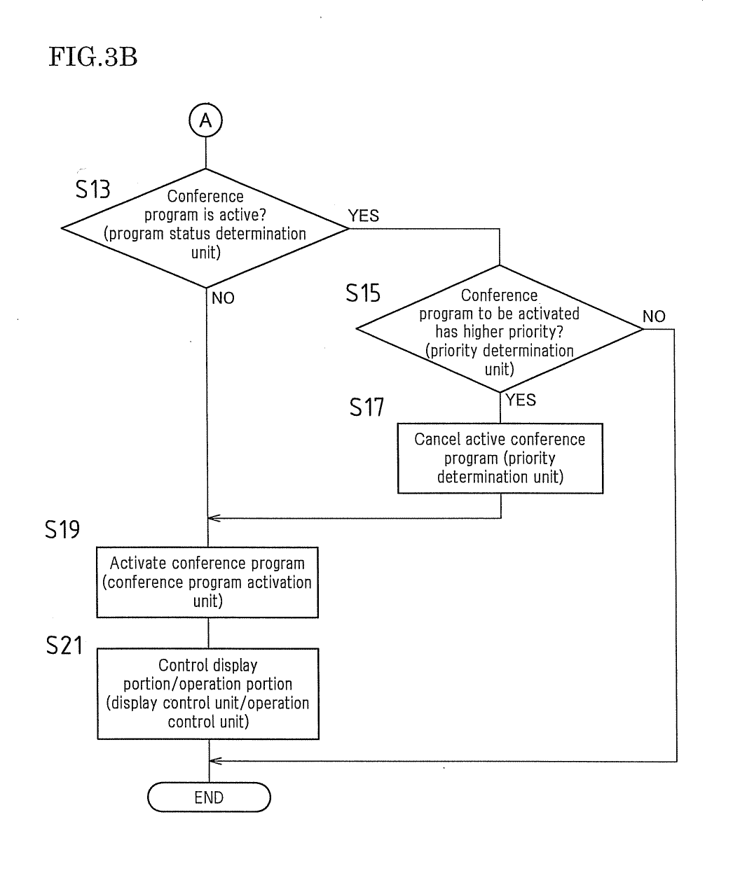

Note that the operations of the function realization units (recognition count determination unit 14, participation terminal information obtaining unit 15, authorization determination unit 16, priority determination unit 17j, program status determination unit 17s, etc.) included in the conference operations terminal 10 will be further described with FIG. 3. The function realization units (similar also in figures subsequent to FIG. 3) are realized by a computer program (computer) preinstalled in a CPU (central processing unit; not shown) included in the conference operations terminal 10.

FIG. 3 is a flowchart illustrating a processing flow of the electronic conferencing system shown in FIG. 2.

The electronic conferencing system 1 and the conference operations terminal 10 according to the present embodiment are operated at an electronic conference using the processing flow of steps S1 through S21 shown in FIG. 3. Hereinafter, the processing of the steps will be described.

Step S1:

The participation terminal recognition unit 90s judges whether a participation terminal 30 has been recognized. If a participation terminal 30 has been recognized (step S1: YES), the processing moves to step S3. If a participation terminal 30 has not been recognized (step S1; NO), the processing returns to the beginning (prior to step S1). Note that the recognition operation is appropriately executed according to the specifications of the applied wireless communication standard.

Step S3:

It is judged whether an authorization condition is set for the electronic conference. This judgment is based on judging whether the authorization determination unit 16 is enabled, for example. If an authorization condition is set (step S3: YES), the processing moves to step S7. If an authorization condition is not set (step S3: NO), the processing moves to step S5.

Note that the authorization condition can, for example, be that the security level of a participation terminal 30 is greater than or equal to a threshold (see FIG. 4). In the case where the authorization condition is that the security level set for a participation terminal 30 is greater than or equal to a threshold, the electronic conferencing system 1 is able to run an electronic conference in which a participation restriction is provided according to security level. For example, this can be handled by configuring settings such that participants having a high security level conduct the conference, by setting security levels separately with regard to rank, division or the like of the participants, and providing participants having a high security level with confirmation authority.

In the present embodiment, the case where an authorization condition is set and the case where an authorization condition is not set (where only the number of participation terminal 30 is recognized) will both be described.

Step S5:

The number of recognized participation terminals 30 (recognition count) is determined by the recognition count determination unit 14 for determining the recognition count. In other words, it is determined whether the recognition count equals a set recognition count that is preset. If it is determined that the recognition count equals the set recognition count (step S5: YES), the processing moves to step S13. On the other hand, if it is determined that the recognition count does not satisfy the set recognition count (step S5: NO), the processing returns to step S1.

Step S7:

The participation terminal information obtaining unit 15 obtains participation terminal information 90j corresponding to an authorization condition for participation in the electronic conference from the participation terminal information database 90d (storage portion 19). For example, information on the security level (security level=1, security level=2, etc.) described at step S3 is obtained. Subsequently, the processing moves to step S9.

Step S9:

The authorization determination unit 16 determines whether the participation terminal information 90j obtained by the participation terminal information obtaining unit 15 meets the authorization condition. For example, if a security level greater than or equal to 1 is set as the authorization condition, a participation terminal 30 having a security level greater than or equal to 1 is judged to the meet the authorization condition. Note that the authorization condition setting is preregistered in the authorization determination unit 16 in association with a corresponding conferencing program 90p.

If the authorization condition is met (step S9: YES), the processing moves to step S11. If the authorization condition is not met (step S9: NO), the processing returns to step S1.

Step S11:

If an authorization condition is set (step S3: YES), the set recognition count is an authorization recognition count that is preset in association with the authorization condition. Accordingly, the recognition count determination unit 14 determines whether the recognition count of participation terminals 30 determined by the authorization determination unit 16 to meet the authorization condition equals the authorization recognition count.

If the recognition count of participation terminals 30 that meet the authorization condition equals the authorization recognition count (step S11: YES), the processing moves to step S13. On the other hand, if the recognition count of participation terminals 30 that meet the authorization condition does not equal the authorization recognition count (step S11: NO), the processing returns to step S1.

Step S13:

Given that the recognition count determination unit 14 determines that the recognition count satisfies the set recognition count (or authorization recognition count), the program status determination unit 17s determines whether a conferencing program 90p (conferencing program extracted from conferencing programs 90p stored in the storage portion 19; normally selected from a plurality of conferencing programs 90p; the following description is premised on there being a plurality of conferencing programs 90p, but the present invention can also be applied to the case of a single conferencing program 90p) is active.

If a conferencing program is not active (step S13: NO), the processing moves to step S19. If a conferencing program is active (step S13: YES), the processing moves to step S15.

Step S15:

The priority of the conferencing program 90p that is active and the priority of the conferencing program 90p that is to be activated are compared. In other words, the priority determination unit 17j determines whether the priority of the conferencing program 90p that is to be activated is higher than the priority of the conferencing program 90p that is active.

Note that the comparison of priorities may be made between conferencing programs 90p for which priorities have been set and conferencing programs 90p for which priorities have not been set. In the case where a priority has not been set for a conferencing program 90p, the priority of the conferencing program 90p is judged to be low. For example, in the case where priorities are set for conferencing programs 90p according to security levels of participation terminals 30, and the smallest value of the security levels of participation terminals 30 participating in an electronic conference (conferencing program 90p) is 2, the conferencing program 90p corresponding to the security level 2 will have a higher priority than the conferencing program 90p corresponding to the security level 1. Also, for example, in the case where priorities are set according to security level, and the smallest value of the security levels of the participation terminals 30 participating in an electronic conference (conferencing program 90p) is 1, the conferencing program 90p corresponding to the security level 1 will have a higher priority than the conferencing program 90p corresponding to the security level 2.

Priorities can be set in correspondence to security level, for example. Specifically, when the security level of participation terminals 30 participating in an electronic conference (conferencing program 90p) is high, a conferencing program 90p corresponding to a high security level can be taken as the conferencing program 90p having the highest priority.

If the priority of the conferencing program 90p that is to be activated is higher than the priority of the conferencing program 90p that is active (step S15: YES), the processing moves to step S17. If the priority of the conferencing program 90p that is to be activated is lower than the priority of the conferencing program 90p that is active (step S15: NO), the processing ends because the conferencing program 90p that is to be activated cannot be activated.

Step S17:

Given that the priority of the conferencing program 90p that is to be activated is higher than the priority of the conferencing program 90p that is active, the conferencing program 90p that is active is ended, and the processing moves to step S19.

Step S19:

Given that the recognition count determination unit 14 determines that the recognition count equals the set recognition count (or the authorization recognition count) that is preset, the conferencing program 90p having the highest priority is activated by the conferencing program activation unit 13. After activating the conferencing program 90p, the processing moves to step S21.

The conferencing program 90p activated by the conferencing program activation unit 13 is, for example, a conferencing application program to be applied to the electronic conference or a program for displaying a conference file 90f to be used at the electronic conference.

Accordingly, the electronic conferencing system 1 of the present embodiment is able to start the electronic conference efficiently and easily, given that launching of a conferencing application program to be applied to the electronic conference or display of a conference file 90f to be used at the electronic conference is executed.

As described above, a plurality of security levels are set in the case where an authorization condition is set, a plurality of conferencing programs 90p are set according to the security levels, and the conferencing program activation unit 13 is configured to activate a conferencing program 90p corresponding to the security level satisfying the authorization condition. Accordingly, the electronic conferencing system 1 is able to improve reliability with respect to security, by being able to set conferencing programs 90p according to security level (e.g., setting a conferencing program 90p only capable of displaying conference files 90f when the security level is low, and setting a conferencing program 90p capable of editing as well as displaying conference files 90f when the security level is high).

Step S21:

The electronic conference is run by controlling the display portion 11p with the display control unit 11 and controlling the operation portion 12p with the operation control unit 12.

The recognition count of participation terminals 30 increases, for instance, when a participation terminal 30 moves from outside to inside a range within which wireless communication with the conference operations terminal 10 using a specific wireless communication standard is possible (with Bluetooth (registered trademark), a range having a radius of about 10-100 m), or when a participation terminal 30 that is inside the range but was not powered on is powered on. The conference operations terminal 10 desirably repeatedly executes the processing of steps S1 through S21 at regular intervals of one minute, for example. A conferencing program 90p can be activated when the recognition count of participation terminals 30 (or the recognition count of participation terminals 30 satisfying an authorization condition) increases to reach the set recognition count (or authorization recognition count).

FIG. 4 is a data table showing a data configuration example of the participation terminal information database 90d shown in FIG. 2.

The conference operations terminal 10 registers (stores) participation terminal information 90j held by the participation terminals 30 in advance in the participation terminal information database 90d. Participation terminal information 90j includes, for example, participation terminal specifications (addresses, security levels, etc. of participation terminals 30) and information on users (participants), which are the terminal holders. Security levels set as participation terminal specifications can be set to a plurality of levels such as from level 1 to level 3, for example. Security levels are defined so as to increase the larger the numeral. User information that can be set includes “Name”, “Head shot” and “Affiliation”, for example.

The configuration of participation terminal information 90j (participation terminal information database 90d) can be changed to various forms as required. Here, a state is shown in which security levels have been set, given that security levels are employed as information for determining priority. Participation terminal information 90j is registered in the participation terminal information database 90d by respective terminal holders 30h. Participation terminal information 90j can also be updated as required. A detailed description is omitted because this merely involves registration of information.

Note that a configuration can also be adopted in which registration of participation terminal information 90j is only possible from a participation terminal 30. This prevents persons who are not terminal holders 30h from using a traced address to register (spoof registration), when addresses included in participation terminal information 90j are registered. Also, the address bit count can be increased to 48 bits, for example, to prevent false recognition.

Security levels can be checked by the authorization determination unit 16 against an authorization condition that is preset for participation terminals 30. In other words, an electronic conference limited to participation terminals 30 satisfying an authorization condition can be implemented, because the authorization determination unit 16 determines whether participation terminal information 90j (participation terminal 30) obtained from the participation terminal information database 90d satisfies a preset authorization condition.

As mentioned above, in the present embodiment, a plurality of security levels are set, enabling a plurality of conferencing programs 90p to be set according to security level. Accordingly, the electronic conferencing system 1 is able to improve reliability with respect to security, by being able to set conferencing programs 90p according to security level (e.g., setting a conferencing program 90p only capable of displaying conference files 90f when the security level is low, and setting a conferencing program 90p capable of editing as well as displaying conference files 90f when the security level is high).

Note that the present embodiment can be appropriately applied to other embodiments. In particular, an electronic conference operations method of the electronic conferencing system 1 to which the electronic conferencing system 1 is applied (see Embodiment 5) and a computer program for causing a computer to execute the electronic conferencing system 1 (see Embodiment 6) share a common basic configuration with the present embodiment.

### Embodiment 2

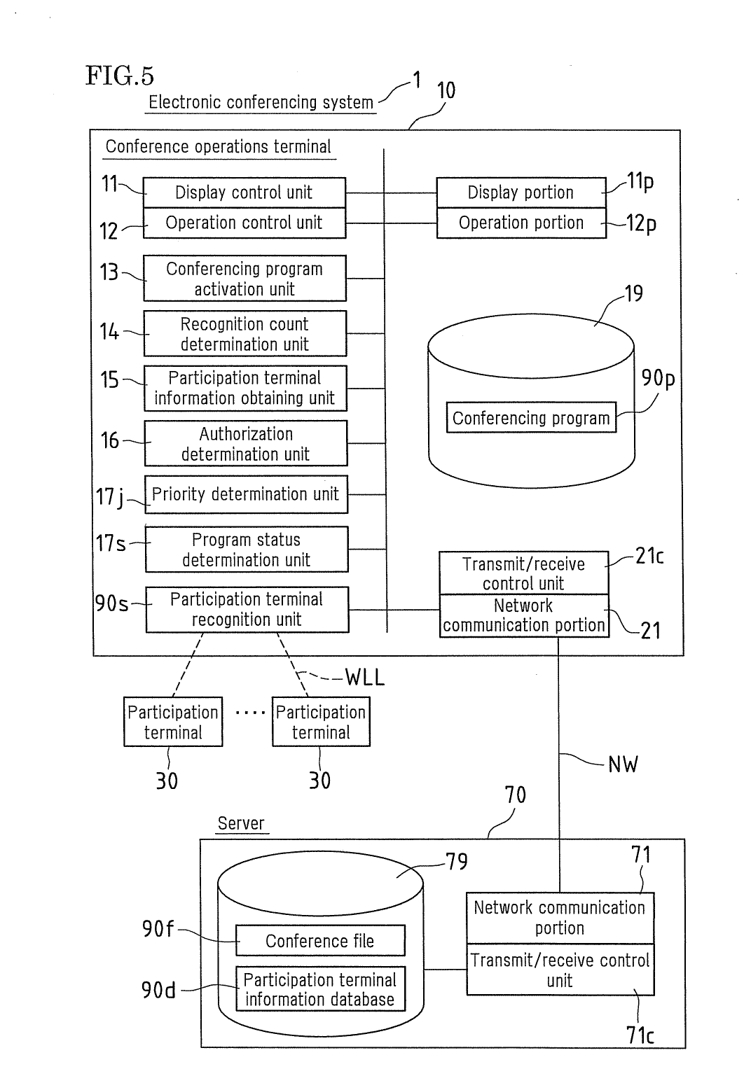

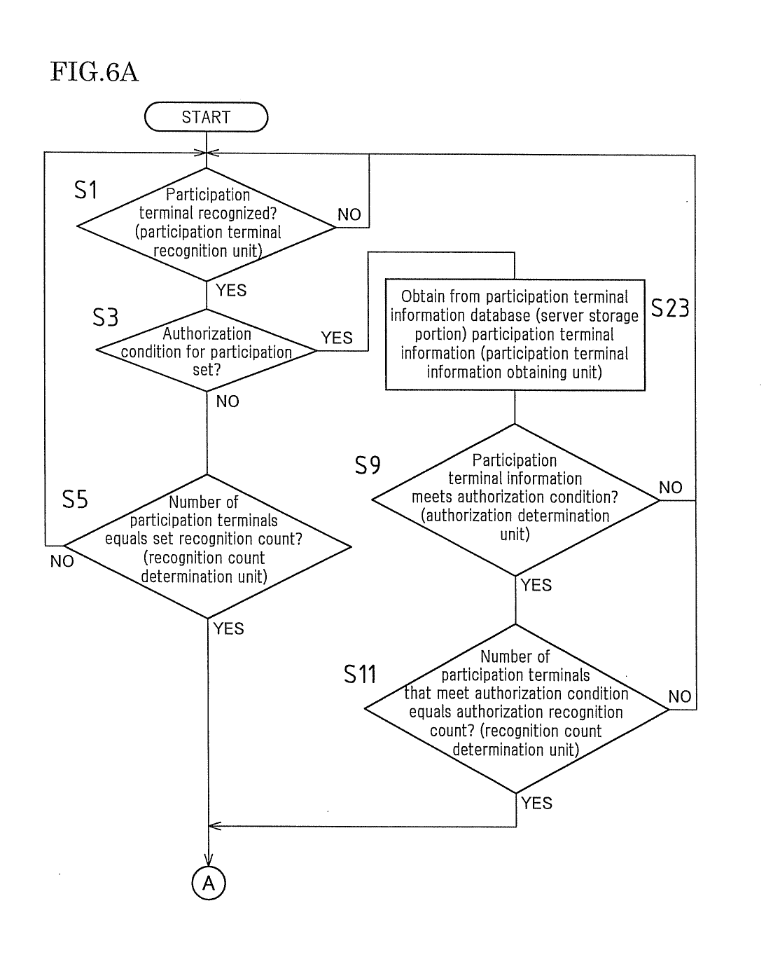

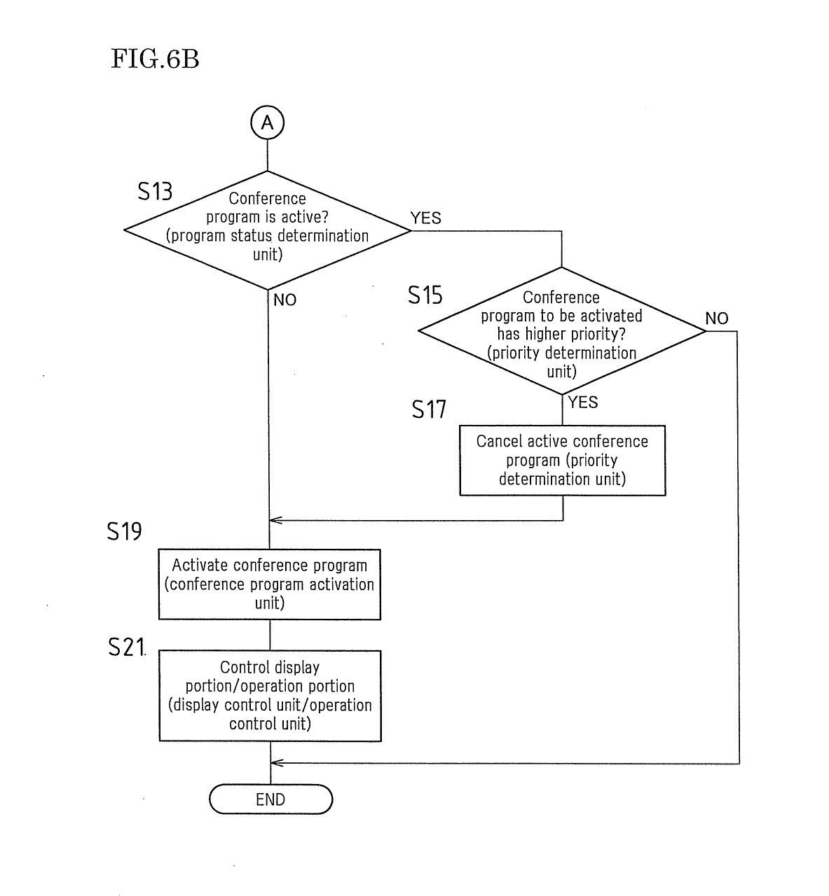

An electronic conferencing system 1 and a conference operations terminal 10 according to the present embodiment will be described with reference to FIGS. 5 and 6. The concept of the electronic conferencing system 1 and the conference operations terminal 10 are similar to Embodiment 1, with conference files 90f and participation terminal information 90j, which could conceivably increase in data volume, being registered (stored) in a server storage portion 79 of a server 70 rather than the storage portion 19 of the conference operations terminal 10.

FIG. 5 is a block diagram showing constituent blocks of the electronic conferencing system 1 and the conference operations terminal 10 according to Embodiment 2 of the present invention.

The basic configuration is similar to the electronic conferencing system 1 and the conference operations terminal 10 shown in Embodiment 1 (FIG. 2), and description will mainly focus on items that differ with the assistance of reference numerals.

With the electronic conferencing system 1 according to the present embodiment, the conference operations terminal 10 is connected to the server 70 via a network NW, and the server 70 has a participation terminal information database 90d.

Accordingly, the electronic conferencing system 1 of the present embodiment is able to smoothly run an electronic conference, given that it is easily and accurately determined whether a participation terminal 30 satisfies an authorization condition for participating in the electronic conference. The memory capacity available for participation terminal information 90j can be increased, given that the participation terminal information database 90d is provided in the server 70.

Note that the participation terminal information database 90d is registered in the server storage portion 79 included in the server 70, and that conference files 90f are also registered in the server storage portion 79. Accordingly, restrictions on the volume of participation terminal information 90j are eased, and utilization of conference material can be achieved because material can be archived and consolidated for an extended period of time.

Communication between the conference operations terminal 10 and the server 70 is executed via a network communication portion 21 and a network communication portion 71. The network communication portion 21 is controlled by a transmit/receive control unit 21c, and the network communication portion 71 is controlled by a transmit/receive control unit 71c.

FIG. 6 is a flowchart illustrating the processing flow of the electronic conferencing system 1 shown in FIG. 5.

The electronic conferencing system 1 and the conference operations terminal 10 according to the present embodiment are operated at an electronic conference using the processing flow of steps S1 through S23 shown in FIG. 6. Hereinafter, the processing of the steps will be described. Steps S1 to S21 are similar to Embodiment 1 (FIG. 3), except for step S7. In the present embodiment, step S7 is replaced by step S23. Accordingly, description will only be supplemented in relation to step S23, and description of the remaining steps will be omitted.

Step S23:

A participation terminal information obtaining unit 15 obtains participation terminal information 90j corresponding to the authorization condition for participation in the electronic conference from the participation terminal information database 90d (server storage portion 79). For example, information on the security level (security level=1, security level=2, etc.) described in step S3 is obtained. Subsequently, the processing moves to step S9.

Note that the present embodiment can be appropriately applied to other embodiments. In particular, an electronic conference operations method of the electronic conferencing system 1 to which the electronic conferencing system 1 is applied (see Embodiment 5) and a computer program for causing a computer to execute the electronic conferencing system 1 (see Embodiment 6) share a common basic configuration with the present embodiment.

### Embodiment 3

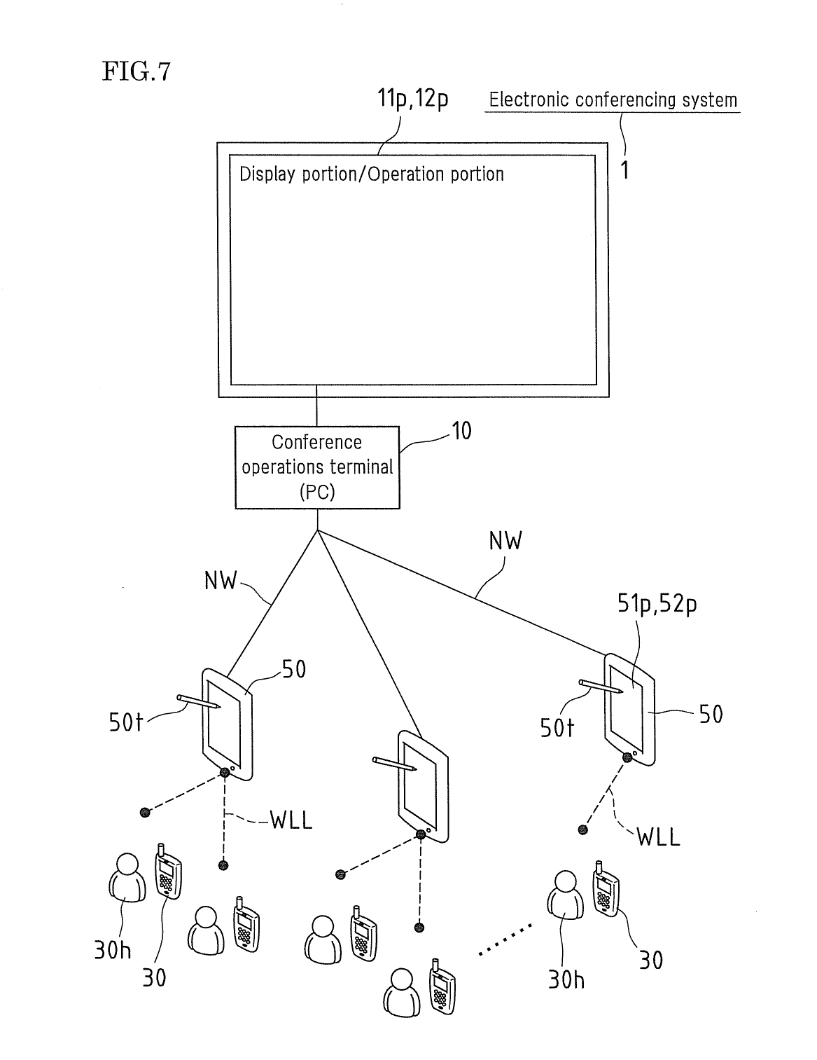

An electronic conferencing system 1 and a conference operations terminal 10 according to the present embodiment will be described with reference to FIGS. 7 through 9. The concept of the electronic conferencing system 1 is similar to Embodiments 1 and 2, with a slave terminal 50 being applied with respect to the conference operations terminal 10. Because the main difference lies in using the slave terminal 50 to recognize a participation terminal 30, description will mainly focus on items that differ, and description of other items will be appropriately omitted.

Note that a flowchart showing the processing flow in the electronic conferencing system 1 is omitted, since the processing flow is similar to Embodiment 1 (FIG. 3) and Embodiment 2 (FIG. 6).

FIG. 7 is a schematic diagram conceptually showing the electronic conferencing system 1 and the conference operations terminal 10 according to Embodiment 3 of the present invention.

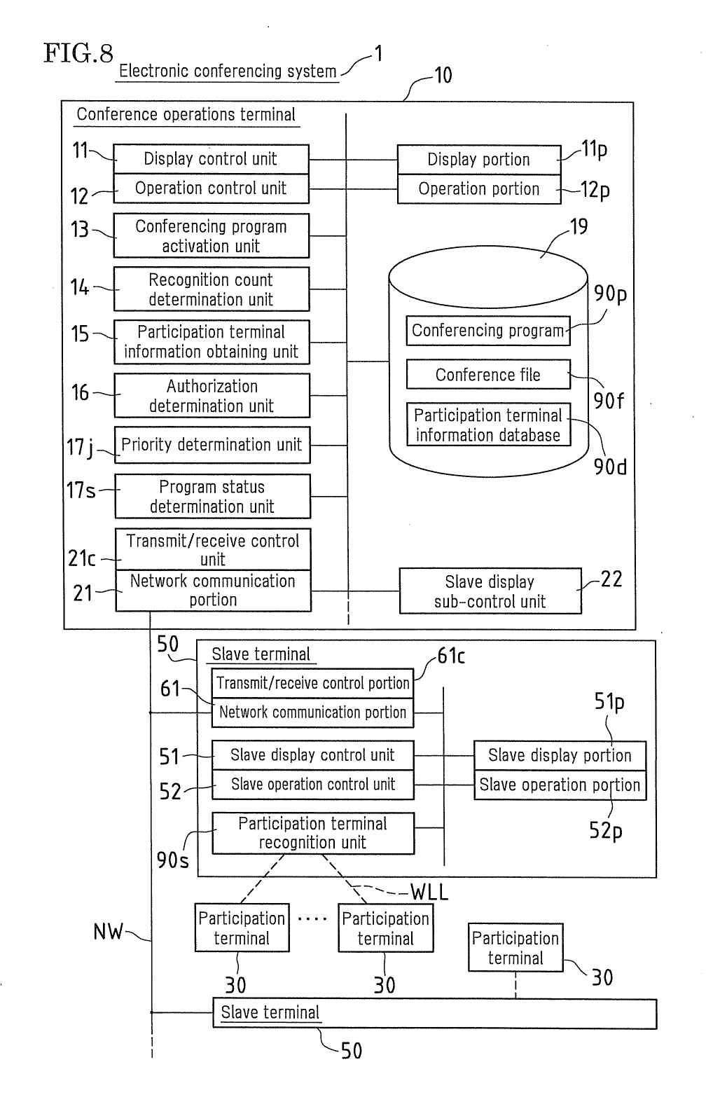

FIG. 8 is a block diagram showing constituent blocks of the electronic conferencing system 1 and the conference operations terminal 10 shown in FIG. 7.

The electronic conferencing system 1 according to the present embodiment is provided with the conference operations terminal 10 to be operated at an electronic conference, a participation terminal 30 to be applied to participation in an electronic conference, and the slave terminal 50 which connects the conference operations terminal 10 and the participation terminal 30. The slave terminal 50 is connected to the conference operations terminal 10 via a network NW. Also, a configuration is adopted in which the participation terminal 30 and the slave terminal 50 are connected with a wireless communication line WLL, and a wireless communication standard of the participation terminal 30 can be effectively utilized.

As for the slave terminal 50, a terminal having functions on a par with a general PC can be applied, similarly to the conference operations terminal 10, although this terminal can be made more compact than the conference operations terminal 10. A PDA (Personal Digital Assistant) or the like is also applicable as the slave terminal 50. Also, a configuration can be adopted, for instance, in which the slave terminal 50 is only a display without an operation portion, or only an operation portion such as a mouse or a keyboard without a display portion. That is, the slave terminal 50 can be constituted by a display device having functions corresponding to the conferencing content (conference operations method) of the electronic conferencing system 1.

Also, the conference operations terminal 10 is provided with a storage portion 19 that stores a conferencing program 90p to be applied to the electronic conference, a recognition count determination unit 14 that determines a recognition count based on participation terminals 30 recognized by a participation terminal recognition unit 90s that recognizes participation terminals 30, and a conferencing program activation unit 13 that activates the conferencing program 90p when the recognition count determination unit 14 determines that the recognition count equals a set recognition count that is preset.

Accordingly, the electronic conferencing system 1 of the present embodiment relieves/eases the load on users of the electronic conferencing system 1, by eliminating the need for necessary tasks such as activating a conference program performed by the person in charge when starting an electronic conference, because participation terminals 30 to be applied to participation in an electronic conference are recognized by the participation terminal recognition unit 90s, a recognition count is determined with a recognition count determination unit 14 based on the recognized participation terminals 30, and when it is determined that the participation terminals 30 satisfy a set recognition count that is preset as a prerequisite for opening the electronic conference, a conferencing program 90p is automatically activated by a conferencing program activation unit 13.

The electronic conferencing system 1 according to the present embodiment is provided with a plurality of slave terminals 50 for communicating with the conference operations terminal 10, and the slave terminals 50 are each provided with the participation terminal recognition unit 90s.

Accordingly, the electronic conferencing system 1 of the present invention enables the number of participation terminals 30 that can be recognized to be increased according to the number of slave terminals, because of recognizing participation terminals 30 via the slave terminals 50 (participation terminal recognition units 90s provided in the slave terminals 50), and is able to relieve restrictions on the number of participation terminals 30, because of being able to increase the number of participation terminals that can be recognized by providing more slave terminals 50, even if there is a restriction on the number of participation terminals that can be recognized with a single participation terminal recognition unit 90s.

The slave terminals 50 are provided with a network communication portion 61, thereby enabling communication with a network communication portion 21 (conference operations terminal 10) provided in the conference operations terminal 10 via the network NW. The network communication portion 61 is controlled by a transmit/receive control portion 61c.

The slave terminals 50 are each provided with a slave display portion 51p and a slave operation portion 52p. The slave display portion 51p and the slave operation portion 52p are, for example, a compact (e.g., portable) display touch panel, with the slave operation portion 52p being a touch panel placed over the slave display portion 51p. The slave display portion 51p and the slave operation portion 52p are controlled by a slave display control unit 51 and a slave operation control unit 52. Configuring the slave display portion 51p and the slave operation portion 52p as a display panel having a touch panel that can be operated with a touch operation unit 50t enables an efficient electronic conference to be realized, by facilitating editing tasks such as directly modifying displayed material (e.g., documents serving as conference files 90f to be used in an electronic conference) while viewing a display screen.

The slave terminals 50 are configured, by receiving a conferencing program 90p from the conference operations terminal 10 and executing the conferencing program 90p, to be able to display conference files 90f on the slave display portion 51p, edit conference files 90f on the slave operation portion 52p, and transmit and receive conference files 90f to and from the conference operations terminal 10. In other words, the slave display portion 51p is configured to display a screen for executing a conferencing program 90p received from the conference operations terminal 10. Accordingly, the electronic conferencing system 1 is able to effectively conduct an electronic conference, because of being able to display a screen for executing a conferencing program 90p (e.g., display a screen for executing a conferencing application program applied to the conferencing program 90p, display a conferencing file 90f applied to the conferencing program 90p, etc.) via a slave terminal 50 (slave display unit 51p).

Note that the conference operations terminal 10 is provided with a slave display sub-control unit 22 in order to display conferencing programs 90p, conference files 90f and a participation terminal information database 90d on the slave display portions 51p. Accordingly, it is possible to easily participate in an electronic conference by remote control, even in if the slave terminal 50 is disposed in a location far removed from the conference operations terminal 10.

Tasks such as editing participation terminal information 90j (e.g., modifying the content thereof) can be executed after calling participation terminal information 90j from the participation terminal information database 90d, for example, given that the slave terminals 50 are provided with the slave display portion 51p and the slave operation portion 52p.

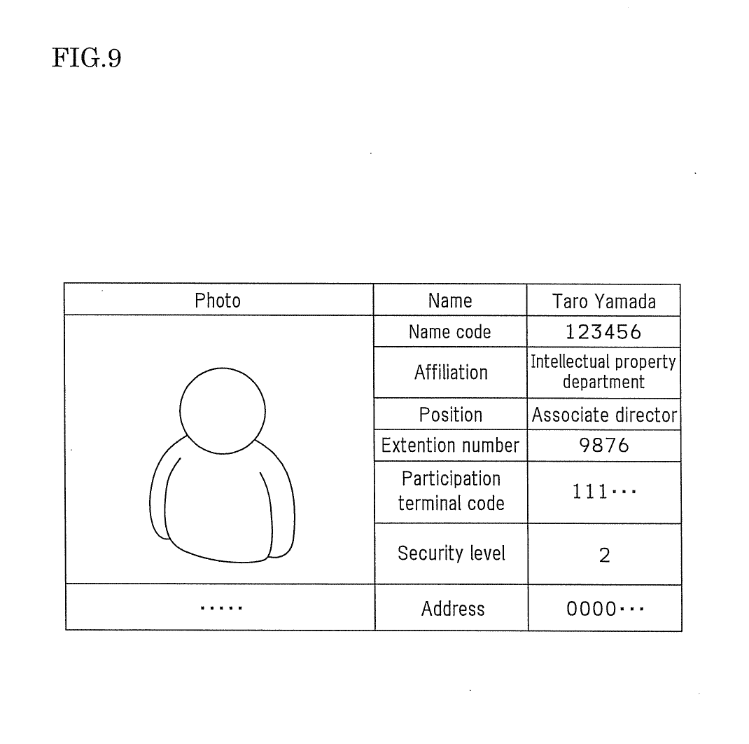

FIG. 9 is a schematic diagram showing a display example of participation terminal information 90j displayed on the slave display portion 51p of a slave terminal 50 shown in FIG. 7.

The slave display portion 51p, while compact, is a fine-resolution screen capable of fine-resolution display, and is able to display a photo, name, name code, affiliation, position, extension number, participation terminal code, security level, address and the like in tabular format.

Because the slave display portion 51p can be configured as the slave operation portion 52p by directly applying the touch operation unit 50t, a terminal holder 30h is able to perform editing tasks on the content of participation terminal information 90j (e.g., updating tasks on participation terminal information 90j) by operating the touch operation unit 50t. The editing tasks with the slave terminals 50 are not limited to participation terminal information 90j, and can also be performed on conference files 90f and the like. Hence, an efficient electronic conference can be realized by facilitating editing tasks such as directly modifying material displayed at an electronic conference (e.g., documents serving as conference files 90f used at an electronic conference) while viewing the slave display portion 51p.

In the present embodiment, given that the slave terminals 50 are applied, the content of step S21, namely, “running an electronic conference by controlling the display portion 11p with the display control unit 11 and controlling the operation unit 12p with the operation control unit 12” also includes the processing flow of “running an electronic conference by controlling the slave display portion 51p with the slave display control unit 51 and controlling the slave operation portion 52p with the slave operation control unit 52.”

Note that the present embodiment can be appropriately applied to other embodiments. In particular, an electronic conference operations method of the electronic conferencing system 1 to which the electronic conferencing system 1 is applied (see Embodiment 5) and a computer program for causing a computer to execute the electronic conferencing system 1 (see Embodiment 6) share a common basic configuration with the present embodiment.

### Embodiment 4

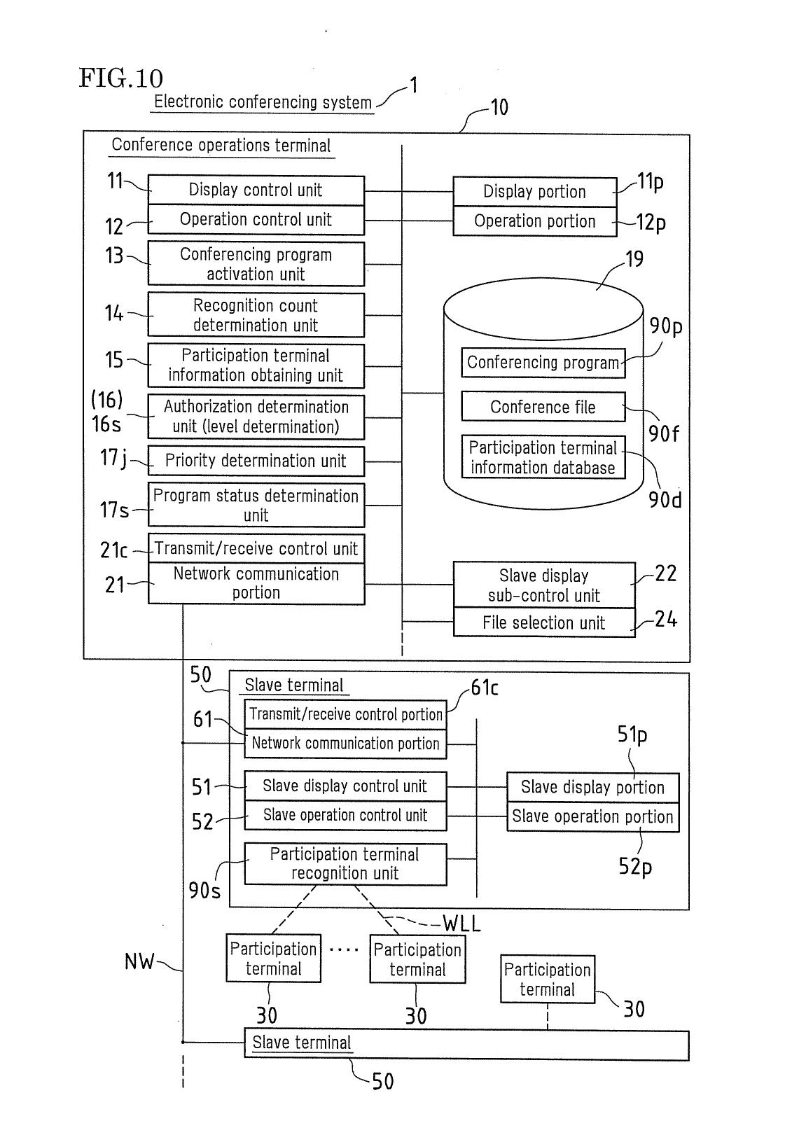

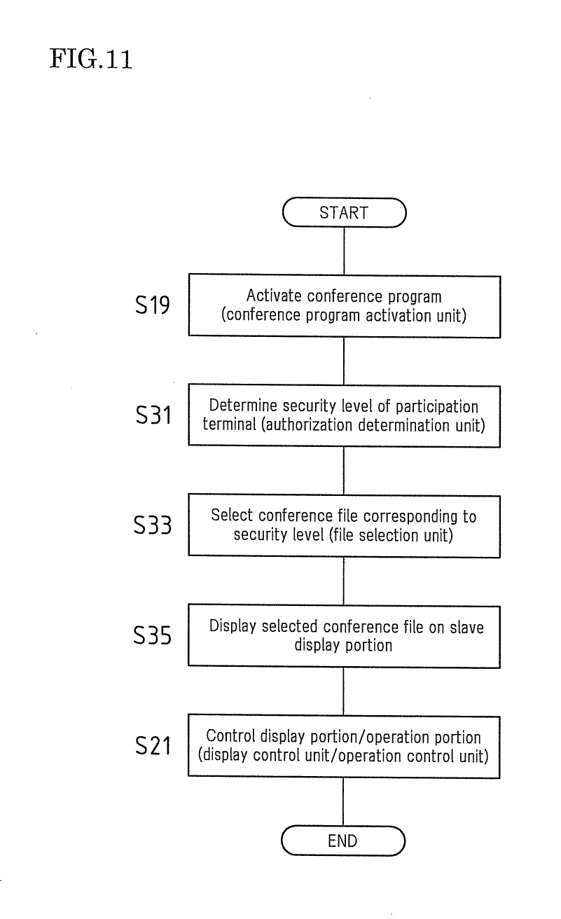

An electronic conferencing system 1 and a conference operations terminal 10 according to the present embodiment will be described with reference to FIGS. 10 and 11. The concept of the electronic conferencing system 1 and the conference operations terminal 10 is similar to Embodiments 1 through 3, with a variation of Embodiment 3, which involved the case where slave terminals 50 are applied with respect to the conference operations terminal 10, being described as Embodiment 4. Because the basic configuration is similar to Embodiment 3, description will mainly focus on items that differ, while description of the remaining items will be appropriately omitted.

FIG. 10 is a block diagram showing constituent blocks of the electronic conferencing system 1 and the conference operations terminal 10 according to Embodiment 4 of the present invention.

The electronic conferencing system 1 and the conference operations terminal 10 according to the present embodiment differ from the electronic conferencing system 1 and the conference operations terminal 10 according to Embodiment 3 (FIG. 8) in that a file selection unit 24 is further provided.

In other words, with the electronic conferencing system 1 according to the present embodiment, the conference operations terminal 10 is provided with a level determination unit 16s that determines a security level of a participation terminal 30, and the file selection unit 24 that selects a conference file 90f according to the security level determined by the level determination unit 16s, with the conference file 90f selected by the file selection unit 24 being displayed on the slave display portion 51p.

Accordingly, the electronic conferencing system 1 detects the security level of the participation terminals 30 for every slave terminal 50, and displays conference files 90f corresponding to the security levels of the participation terminals 30. Hence, strict security can be ensured even in the case where the number of slave terminals 50 is increased.

Note that the level determination unit 16s can handle this by replacing the determination criterion of the authorization determination unit 16 (see Embodiments 1 through 3) with security levels (security level determination). Accordingly, the authorization determination unit 16 and the level determination unit 16s can be configured as substantively identical function realization units.

FIG. 11 is a flowchart illustrating the processing flow of the electronic conferencing system 1 shown in FIG. 10.

The electronic conferencing system 1 and the conference operations terminal 10 according to the present embodiment are operated at an electronic conference using the processing flow of steps S1 through S23 shown in FIG. 6. Hereinafter, the processing of the steps will be described. Steps S31 to S35 according to the present embodiment desirably are incorporated between steps S19 and S21 (Embodiment 1 (FIG. 3), Embodiment 2 (FIG. 6)). Accordingly, description regarding the processing flow between steps S19 and S21 will be supplemented, and description of the remaining steps will be omitted.

Step S19:

Given that the recognition count determination unit 14 determines that the recognition count equals the set recognition count (or the authorization recognition count) that is preset, the conferencing program 90p is activated by the conferencing program activation unit 13. After activating the conferencing program 90p, the processing moves to step S31.

Step S31:

The security level of the participation terminal 30 is determined by the authorization determination unit 16. Note that in the case where “security level greater than or equal to a threshold” is selected as the authorization condition as shown in Embodiment 1, this step can be omitted given that the security level for the participation terminal 30 has already been determined in step S9.

Step S33:

A conference file 90f corresponding to the security level is selected by the file selection unit 24. For example, a configuration can be adopted in which a conference file 90f that is merely conference material, for example, is selected if the security level is low, and a conference file 90f designated as confidential material, for example, is selected if the security level is high. As for the type of material in the case of the security level being high, material produced in color or the like may be selected apart from confidential material.

Note that, at this time, the slave display sub-control unit 22 is configured to judge, when a conference file 90f is already being displayed on the slave display portion 51p, whether the conference file 90f that is already being displayed corresponds to the selected security level.

By causing the slave display sub-control unit 22 to determine the content of a conference file 90f that is already being displayed, a conference file 90f corresponding to the security level can be displayed, in the case where the participation terminal 30 is replaced by a participation terminal 30 having a low security level. Also, a conference file 90f corresponding to the security level can be displayed, in the case where the participation terminal 30 is replaced by a participation terminal 30 having a high security level.

Accordingly, the reliability of the security levels can be improved, given that display corresponding to the security level of participation terminals 30 can be performed.

Step S35:

The selected conference file 90f is displayed on the slave display portion 51p by the slave display sub-control unit 22.

Step S21:

The electronic conference is run by controlling the display portion 11p with the display control unit 11 and controlling the operation portion 12p with the operation control unit 12. Note that in the present embodiment, the electronic conference is run by also controlling the slave display portion 51p with the slave display control unit 51 and controlling the slave operation portion 52p with the slave operation control unit 52.

Note that the present embodiment can be appropriately applied to other embodiments. In particular, an electronic conference operations method of the electronic conferencing system 1 to which the electronic conferencing system 1 is applied (see Embodiment 5) and a computer program for causing a computer to execute the electronic conferencing system 1 (see Embodiment 6) share a common basic configuration with the present embodiment.

### Embodiment 5

In Embodiments 1 to 4, an electronic conferencing system and an conference operations terminal constituted mainly by electronic devices such as an electronic conferencing system 1, an conference operations terminal 10, a participation terminal 30 and a slave terminal 50 were described, but the present invention is not limited to an electronic conferencing system and an conference operations terminal, and can be embodied as an electronic conference operations method of an electronic conferencing system.

Accordingly, in the present embodiment, an electronic conference operations method that utilizes the electronic conferencing system 1 will be described in association with the electronic conferencing system 1. Note that because the operations and effects are similar to those of the electronic conferencing system 1 (Embodiments 1 through 4), description will mainly focus on the configuration of the electronic conference operations method.

The electronic conference operations method according to the present embodiment utilizes an electronic conferencing system 1 provided with a conference operations terminal 10 to be operated at an electronic conference and a participation terminal 30 to be applied to participation in the electronic conference, the conference operations terminal 10 storing a conferencing program 90p to be applied to the electronic conference, and the electronic conference operations method including a recognition count determination step (recognition count determination unit 14) of the conference operations terminal 10 determining a recognition count based on participation terminals 30 recognized in a participation terminal recognition step of recognizing participation terminals 30 (the participation terminal recognition step is executed by the participation terminal recognition unit 90s; hereinafter, the other steps are similarly executed by similarly corresponding units; accordingly, description will hereinafter be kept to disclosing the names of the corresponding units), and a conferencing program activation step (conferencing program activation unit 13) of the conference operations terminal 10 activating the conferencing program 90p, when it is determined in the recognition count determination step (recognition count determination unit 14) that the recognition count equals a set recognition count that is preset.

With the electronic conference operations method according to the present embodiment, the conference operations terminal 10 executes the participation terminal recognition step (participation terminal recognition unit 90s).

Also, with the electronic conference operations method according to the present embodiment, a plurality of slave terminals 50 that communicate with the conference operations terminal 10 are provided, and the slave terminals 50 each execute the participation terminal recognition step (participation terminal recognition unit 90s).

Also, with the electronic conference operations method according to the present embodiment, the slave terminals 50 are provided with a slave display portion 51p, and the slave display portion 51p displays a screen for executing a conference program received from the conference operations terminal 10.

Also, the electronic conference operations method according to the present embodiment further includes a participation terminal information obtaining step (participation terminal information obtaining unit 15) of the conference operations terminal 10 obtaining, from a participation terminal information database 90d that registers participation terminal information 90j held by participation terminals 30, participation terminal information 90j corresponding to an authorization condition for participation in an electronic conference, and an authorization determination step (authorization determination unit 16) of the conference operations terminal 10 determining whether the participation terminal information 90j obtained in the participation terminal information obtaining step (participation terminal information obtaining unit 15) meets the authorization condition. The set recognition count is an authorization recognition count that is preset in association with the authorization condition, and in the recognition count determination step (recognition count determination unit 14) it is determined whether the recognition count of participation terminals 30 determined in the authorization determination step (authorization determination unit 16) to meet the authorization condition equals the authorization recognition count.

Also, with the electronic conference operations method according to the present embodiment, the conference operations terminal 10 retains the participation terminal information database 90d.

Also, with the electronic conference operations method according to the present embodiment, the conference operations terminal 10 is connected to a server 70 via a network NW, and the server 70 retains the participation terminal information database 90d.

Also, with the electronic conference operations method according to the present embodiment, the authorization condition is that the security level set for a participation terminal 30 is greater than or equal to a threshold.

Also, with the electronic conference operations method according to the present embodiment, a plurality of security levels are set, a plurality of conferencing programs 90p are set according to the security levels, and in the conferencing program activation step (conferencing program activation unit 13) a conferencing program 90p corresponding to the security level satisfying the authorization condition is activated.

Also, the electronic conference operations method according to the present embodiment further includes a program status determination step (program status determination unit 17s) of the conference operations terminal 10 determining whether a conferencing program 90p is already active, and a priority determination step (priority determination unit 17j) of the conference operations terminal 10 comparing, when it is determined in the program status determination step (program status determination unit 17s) that a conferencing program 90p is active, a priority of the conferencing program 90p that is already active and a priority of a conferencing program 90p that is to be activated.

Also, with the electronic conference operations method according to the present embodiment, in the priority determination step (priority determination unit 17j), the conferencing program 90p that is already active is terminated, when the priority of the conferencing program 90p that is to be activated is higher than the conferencing program 90p that is already active, and processing on the conferencing program 90p that is to be activated is terminated, when the priority of the conferencing program 90p that is to be activated is lower than the conferencing program 90p that is already active.

Also, with the electronic conference operations method according to the present embodiment, the conferencing program 90p activated in the conferencing program activation step (conferencing program activation unit 13) is a conferencing application program to be applied to the electronic conference or a program for displaying a conference file 90f to be used at the electronic conference.

Also, with the electronic conference operations method according to the present embodiment, a participation terminal 30 is a terminal device satisfying a preselected wireless communication standard.

Also, the electronic conference operations method according to the present embodiment further includes a level determination step (level determination unit 16s) of the conference operations terminal 10 determining a security level of a participation terminal, and a file selection step (file selection unit 24) of the conference operations terminal 10 selecting a conference file 90f according to the security level determined in the level determination step (level determination unit 16s), and the conference file 90f selected in the file selection step (file selection unit 24) is displayed on the slave display portion 51p.

### Embodiment 6

The invention according to Embodiment 5 was described as an electronic conference operations method of an electronic conferencing system 1 (conference operations terminal 10, participation terminal 30, slave terminal 50, etc.), with the conference operations terminal 10 and the slave terminal 50 applying a computer such a PC (personal computer) and a computer program. Accordingly, the electronic conference operations method of the electronic conferencing system 1 can be directly embodied as a computer program.

Accordingly, the present embodiment will be described as a computer program for causing a computer to realize the electronic conference operations method of the electronic conferencing system 1. Note that because the operations and effects are similar to those of the electronic conference operations method (Embodiment 5) of the electronic conferencing system 1 (Embodiments 1 through 4), description will mainly focus on the configuration of the computer program.

The computer program according to the present embodiment causes a computer to execute an electronic conferencing system 1 provided with a conference operations terminal 10 to be operated at an electronic conference and a participation terminal 30 to be applied to participation in an electronic conference, a conferencing program 90p to be applied to an electronic conference is provided in the conference operations terminal 10, and the program causes the conference operations terminal 10 to execute a recognition count determination step (recognition count determination unit 14) of determining a recognition count based on participation terminals 30 recognized in a participation terminal recognition step of recognizing participation terminals 30 (the participation terminal recognition step is executed as the participation terminal recognition unit 90s by a computer program; hereinafter, the other steps are also similarly executed by similarly corresponding units; accordingly, description will hereinafter be kept to disclosing the names of the corresponding units), and a conferencing program activation step (conferencing program activation unit 13) of activating the conferencing program 90p, when it is determined in the recognition count determination step (recognition count determination unit 14) that the recognition count equals a set recognition count that is preset.

The computer program product according to the present embodiment includes a computer-readable storage medium having recorded thereon a computer-readable program, the program being for causing a computer to function as an conference operations terminal 10 to be operated at an electronic conference realized by an electronic conferencing system 1 provided with a participation terminal 30 to be applied to participation in the electronic conference, the conference operations terminal 10 storing a conferencing program to be applied to the electronic conference, and the program, when executed on the computer, causing the computer to execute a recognition count determination step of determining a recognition count based on participation terminals 30 recognized in a participation terminal recognition step of recognizing participation terminals 30, and a conferencing program activation step of activating the conferencing program, when it is determined in the recognition count determination step that the recognition count equals a set recognition count that is preset.

The storage medium is, for example, a semiconductor memory such as RAM (Random Access Memory), mask ROM (Read Only Memory), EPROM (Erasable Programmable Read Only Memory), EEPROM (Electrically Erasable Programmable Read Only Memory) or flash memory, a magnetic recording medium such as a hard disk, or an optical recording medium such as CD-ROM (Compact Disc Read Only Memory), DVD (Digital Versatile Disc), or Blu-ray Disc (registered trademark).

Also, with the computer program according to the present embodiment, the conference operations terminal 10 is caused to execute the participation terminal recognition step (participation terminal recognition unit 90s).

Also, with the computer program according to the present embodiment, a plurality of slave terminals 50 that communicate with the conference operations terminal 10 are provided, and the slave terminals 50 are each caused to execute the participation terminal recognition step (participation terminal recognition unit 90s).

Also, with the computer program according to the present embodiment, the slave terminals 50 are provided with a slave display portion 51p, and the slave display portion 51p is caused to display a screen for executing a conference program received from the conference operations terminal 10.

Also, with the computer program according to the present embodiment, the conference operations terminal 10 is caused to execute a participation terminal information obtaining step (participation terminal information obtaining unit 15) of obtaining, from a participation terminal information database 90d that registers participation terminal information 90j held by participation terminals 30, participation terminal information 90j corresponding to an authorization condition for participation in an electronic conference, and an authorization determination step (authorization determination unit 16) of determining whether the participation terminal information 90j obtained in the participation terminal information obtaining step (participation terminal information obtaining unit 15) meets the authorization condition. The set recognition count is an authorization recognition count that is preset in association with the authorization condition, and it is determined in the recognition count determination step (recognition count determination unit 14) whether the recognition count of participation terminals 30 determined in the authorization determination step (authorization determination unit 16) to meet the authorization condition equals the authorization recognition count.

Also, with the computer program according to the present embodiment, the conference operations terminal 10 is caused to retain the participation terminal information database 90d.

Also, with the computer program according to the present embodiment, the conference operations terminal 10 is connected to a server 70 via a network NW, and the server 70 is caused to retain the participation terminal information database 90d.

Also, with the computer program according to the present embodiment, the authorization condition is a security level set for the participation terminals 30.

Also, with the computer program according to the present embodiment, a plurality of security levels are set, a plurality of conferencing programs 90p are set according to the security levels, and in the conferencing program activation step (conferencing program activation unit 13) a conferencing program 90p corresponding to the security level satisfying the authorization condition is activated.

Also, the computer program according to the present embodiment causes the conference operations terminal 10 to execute a program status determination step (program status determination unit 17s) of determining whether a conferencing program 90p is already active, and a priority determination step (priority determination unit 17j) of, when it is determined in the program status determination step (program status determination unit 17s) that a conferencing program 90p is active, comparing a priority of the conferencing program 90p that is already active and a priority of a conferencing program 90p that is to be activated.

Also, with the computer program according to the present embodiment, in the priority determination step (priority determination unit 17j), the conferencing program 90p that is already active is terminated, when the priority of the conferencing program 90p that is to be activated is higher than the conferencing program 90p that is already active, and processing on the conferencing program 90p that is to be activated is terminated, when the priority of the conferencing program 90p that is to be activated is lower than the conferencing program 90p that is already active.

Also, with the computer program according to the present embodiment, the conferencing program 90p activated in the conferencing program activation step (conferencing program activation unit 13) is caused to execute the functions of a conferencing application program to be applied to the electronic conference or to display a conference file 90f to be used at the electronic conference.

Also, with the computer program according to the present embodiment, a participation terminal 30 is a terminal device satisfying a preselected wireless communication standard.

Also, with the computer program according to the present embodiment, the conference operations terminal 10 is caused to execute a level determination step (level determination unit 16s) of determining a security level of a participation terminal, and a file selection step (file selection unit 24) of selecting a conference file 90f according to the security level determined in the level determination step (level determination unit 16s), and to display the conference file 90f selected in the file selection step (file selection unit 24) on the slave display portion 51p.

The present invention may be embodied in various other forms without departing from the gist or essential characteristics thereof. Therefore, the embodiments disclosed herein are to be considered in all respects as illustrative and not limiting. The scope of the invention is indicated by the appended claims rather than by the foregoing description. All variations and modifications that come within the meaning and range of equivalency of the claims are intended to be embraced therein.

What is claimed is:

1. An electronic conferencing system comprising a conference operations terminal to be operated at an electronic conference and a participation terminal to be applied to participation in the electronic conference, the conference operations terminal including:
a storage portion that stores a conferencing program to be applied to the electronic conference;
a recognition count determination unit that determines a recognition count based on the participation terminal recognized by a participation terminal recognition unit that recognizes the participation terminal; and
a conferencing program activation unit that activates the conferencing program, when the recognition count determination unit determines that the recognition count equals a set recognition count that is preset.

2. The electronic conferencing system according to claim 1, wherein the conference operations terminal includes the participation terminal recognition unit.

3. The electronic conferencing system according to claim 1, comprising a plurality of slave terminals that communicate with the conference operations terminal,
wherein the slave terminals each include the participation terminal recognition unit.

4. The electronic conferencing system according to claim 3,
wherein the slave terminals include a slave display portion, and
the slave display portion is configured to display a screen for executing the conferencing program received from the conference operations terminal.

5. The electronic conferencing system according to claim 1,
wherein the conference operations terminal includes:
a participation terminal information obtaining unit that obtains, from a participation terminal information database that registers participation terminal information held by the participation terminal, participation terminal information corresponding to an authorization condition for participation in the electronic conference; and
an authorization determination unit that determines whether the participation terminal information obtained by the participation terminal information obtaining unit meets the authorization condition,
the set recognition count is an authorization recognition count that is preset in association with the authorization condition, and
the recognition count determination unit is configured to determine whether the recognition count of the participation terminal determined by the authorization determination unit to meet the authorization condition equals the authorization recognition count.

6. The electronic conferencing system according to claim 5, wherein the conference operations terminal has the participation terminal information database.

7. The electronic conferencing system according to claim 5,
wherein the conference operations terminal is connected to a server via a network, and
the server has the participation terminal information database.

8. The electronic conferencing system according to claim 5, wherein the authorization condition is that a security level set for the participation terminal is greater than or equal to a threshold.

9. The electronic conferencing system according to claim 8,
wherein a plurality of security levels are set,
a plurality of conferencing programs are set according to the security levels, and
the conferencing program activation unit is configured to activate the conferencing program corresponding to the security level satisfying the authorization condition.

10. The electronic conferencing system according to claim 9,
wherein the conference operations terminal includes:
a program status determination unit that determines whether a conferencing program is already active; and
a priority determination unit that, when the program status determination unit determines that a conferencing program is active, compares a priority of the conferencing program that is active and a priority of a conferencing program that is to be activated, and
the priority determination unit is configured to terminate the conferencing program that is active when the priority of the conferencing program that is to be activated is higher than the priority of the conferencing program that is active, and to terminate processing on the conferencing program that is to be activated when the priority of the conferencing program that is to be activated is lower than the priority of the conferencing program that is active.

11. The electronic conferencing system according to claim 1, wherein the conferencing program that is activated by the conferencing program activation unit is one of a conferencing application program to be applied to the electronic conference and a program for displaying a conference file to be used at the electronic conference.

12. The electronic conferencing system according to claim 1, wherein the participation terminal is a terminal device satisfying a preselected wireless communication standard.

13. The electronic conferencing system according to claim 4,
wherein the conference operations terminal
includes a level determination unit that determines a security level of the participation terminal, and a file selection unit that selects a conference file according to the security level determined by the level determination unit, and
is configured to display the conference file selected by the file selection unit on the slave display portion.

14. An electronic conference operations method of an electronic conferencing system including a conference operations terminal to be operated at an electronic conference and a participation terminal to be applied to participation in the electronic conference, the conference operations terminal storing a conferencing program to be applied to the electronic conference, comprising:
a recognition count determination step of the conference operations terminal determining a recognition count based on the participation terminal recognized in a participation terminal recognition step of recognizing the participation terminal; and
a conferencing program activation step of the conference operations terminal activating the conferencing program, when it is determined in the recognition count determination step that the recognition count equals a set recognition count that is preset.

15. A computer program product including a computer-readable storage medium having recorded thereon a computer-readable program, the program being for causing a computer to function as a conference operations terminal to be operated at an electronic conference realized by an electronic conferencing system including a participation terminal to be applied to participation in the electronic conference, and the conference operations terminal storing a conferencing program to be applied to the electronic conference, the program, when executed on the computer, causing the computer to execute:
a recognition count determination step of determining a recognition count based on the participation terminal recognized in a participation terminal recognition step of recognizing the participation terminal; and
a conferencing program activation step of activating the conferencing program, when it is determined in the recognition count determination step that the recognition count equals a set recognition count that is preset.

16. A conference operations terminal to be operated at an electronic conference realized by an electronic conferencing system including a participation terminal to be applied to participation in the electronic conference, comprising:
a storage portion that stores a conferencing program to be applied to the electronic conference;
a recognition count determination unit that determines a recognition count based on the participation terminal recognized by a participation terminal recognition unit that recognizes the participation terminal; and
a conferencing program activation unit that activates the conferencing program, when the recognition count determination unit determines that the recognition count equals a set recognition count that is preset.
